(19) United States
(12) Patent Application Publication
(10) Pub. No.: US 2020/0332835 A1
(43) Pub. Date: Oct. 22, 2020

(54) BALL BEARING AND BALL BEARING CAGE

(71) Applicants: DAIBEA CO., LTD., Izumi-shi (JP); JTEKT CORPORATION, Osaka-shi (JP)

(72) Inventors: Hiroshi UENO, Osakasayama-shi (JP); Tomoe MIZOKOSHI, Osaka-shi (JP); Kazuki HAMADA, Kashiwara-shi (JP); Isao USUKI, Yamatotakada-shi (JP)

(73) Assignees: DAIBEA CO., LTD., Izumi-shi (JP); JTEKT CORPORATION, Osaka-shi (JP)

(21) Appl. No.: 16/840,758

(22) Filed: Apr. 6, 2020

(30) Foreign Application Priority Data
Apr. 18, 2019 (JP) 2019-079467

(51) Int. Cl. F16C 33/38

(52) U.S. Cl. CPC F16C 33/3806; F16C 2240/46; F16C 2240/12

(57) ABSTRACT

A noise due to contact of a cage of an angular contact ball bearing to an outer ring to be outer ring guided is reduced. The angular contact ball bearing includes an outer ring, an inner ring, a plurality of balls, and a cage. The cage includes a plurality of pockets for accommodating the balls arranged at circumferential intervals and the rotation of the cage is guided by the outer ring or the inner ring, which serves as a guide ring. The pocket is provided at an inner surface thereof with an engaging portion which projects into the pocket. The engaging portion engages with the ball in the pocket when the cage is moved in a radial direction prior to contact of the cage to the guide ring.

### TECHNICAL FIELD

The present invention relates to a ball bearing and a ball bearing cage.

### BACKGROUND ART

A ball bearing has been used in a variety of applications, such as, e.g., an application for supporting a shaft of a machine tool. Further, as a ball bearing, there is an angular contact ball bearing provided with an inner ring, an outer ring, balls, a cage, and the like (e.g., see Japanese Unexamined Patent Application Publication No. 2018-105504).

### SUMMARY OF THE INVENTION

### Technical Problem

A cage used in a ball bearing is guided by an outer ring, an inner ring, or balls, so that radial vibrations thereof due to rotation are suppressed. For example, in the case of a cage in which the rotation is guided by an outer ring (hereinafter also referred to as “outer ring guided”), the outer circumference surface of the cage comes into contact with the inner circumference surface of the outer ring, so that the radial vibrations are suppressed. However, there is a problem that a contact sound or a collision sound due to contact of the cage to the outer ring causes noise, and this problem becomes more noticeable as the support shaft rotates at a higher speed. In the case of an angular contact ball bearing, the rotation of the cage is guided by the inner circumference surface of the shoulder on one axial direction side of the outer ring, causing unstable rotation of the cage, which is likely to cause noise.

It is an object of the present invention to reduce noise due to contact of a cage of a ball bearing to a guide wheel.

### Solution to Problem

(1) A ball bearing according to the present invention includes:

an outer ring provided with a raceway on an inner circumference;

an inner ring arranged radially inward of the outer ring and provided with a raceway on an outer circumference;

a plurality of balls arranged between the raceway of the outer ring and the raceway of the inner ring; and

a cage configured to maintain circumferential intervals of the plurality of balls,

wherein the cage is provided with a plurality of pockets for accommodating the balls at circumferential intervals and is configured to be rotationally guided by the outer ring or the inner ring, which serves as a guide ring,

wherein the pocket is provided at an inner surface thereof with an engaging portion which projects into the pocket, and

wherein the engaging portion engages with the ball in the pocket prior to contact of the cage to the guide ring when the cage is moved in a radial direction.

The present invention relates to a cage for maintaining circumferential intervals of a plurality of balls in a ball bearing,

wherein the cage is provided with a plurality of pockets for accommodating the balls and rotation of the cage is guided by an outer ring or an inner ring of the ball bearing, which serves as a guide ring,

wherein the pocket is provided at an inner surface thereof with an engaging portion which projects into the pocket, and

wherein the engaging portion engages with the ball in the pocket when the cage is moved in a radial direction prior to contact of the cage to the guide ring.

According to the above-described ball bearing and cage, when radial vibrations occur in the cage, first, the engaging portion engages with the ball in the pocket, and then the cage comes into contact with the guide ring. For this reason, the contact sound and the collision sound due to contact of the cage to the guide ring are suppressed, so that generation of noise can be reduced.

Preferably, the guide ring is provided with a guide surface to which the cage comes into contact, and a radial gap between the engaging portion and the ball is smaller than a radial gap between the guide surface and the cage.

With this configuration, when the cage is moved in a radial direction, it becomes possible to make the engaging portion come into contact with the ball prior to contact of the cage to the guide surface.

Preferably, the outer ring is provided with a counterbore arranged on one axial side of the raceway and a shoulder arranged on the other axial side of the raceway, and an inner circumference surface of the shoulder serves as a guide surface for guiding rotation of the cage.

In the case of an angular contact ball bearing in which the cage is outer ring guided, the cage is guided by the inner circumference surface of the shoulder arranged on one axial direction side of the outer ring, and therefore it is likely to become unstable and generate noise. Therefore, it is more effective to apply the present invention to an angular contact ball bearing.

Preferably, the engaging portion engages with the ball in the pocket from a radially outward side.

In this case, when a part of the cage in the circumferential direction moves radially outward, the engaging portion engages with the ball in the pocket at the other portion of the cage radially opposite to the part of the cage. As a result, it is possible to suppress the collision sound and the contact sound of the cage with respect to the guide surface.

Preferably, the engaging portion is composed of a pair of engaging portions provided to face each other.

With this confirmation, it possible to reduce the weight of the cage as compared with a configuration in which two or more pairs of engaging portions are provided on the inner surface of the pocket.

### Advantageous Effects of Invention

According to the present invention, it is possible to reduce noise due to contact of the cage of the ball to the guide ring.

### BRIEF DESCRIPTION OF THE DRAWINGS

FIG. 1 is a cross-sectional view of a ball bearing according to a first embodiment of the present invention.

FIG. 2 is a schematic view of a part of a cage as seen from a radially outward side.

(a) of FIG. 3 is a partially enlarged cross-sectional view showing a part of the ball bearing, and (b) of FIG. 3 is an enlarged cross-sectional view of the portion A indicated in (a) of FIG. 3.

FIG. 4 is an enlarged perspective view of a part of the cage.

FIG. 5 is a schematic view of a part of a cage of a ball bearing according to a second embodiment as seen from a radially outward side.

FIG. 6 is an enlarged cross-sectional view of a part of a ball bearing according to a third embodiment.

FIG. 7 is a cross-sectional view showing a cage of an invention of a prior application.

### DESCRIPTION OF EMBODIMENTS

Hereinafter, embodiments of the present invention will be described with reference to the attached drawings.

### First Embodiment

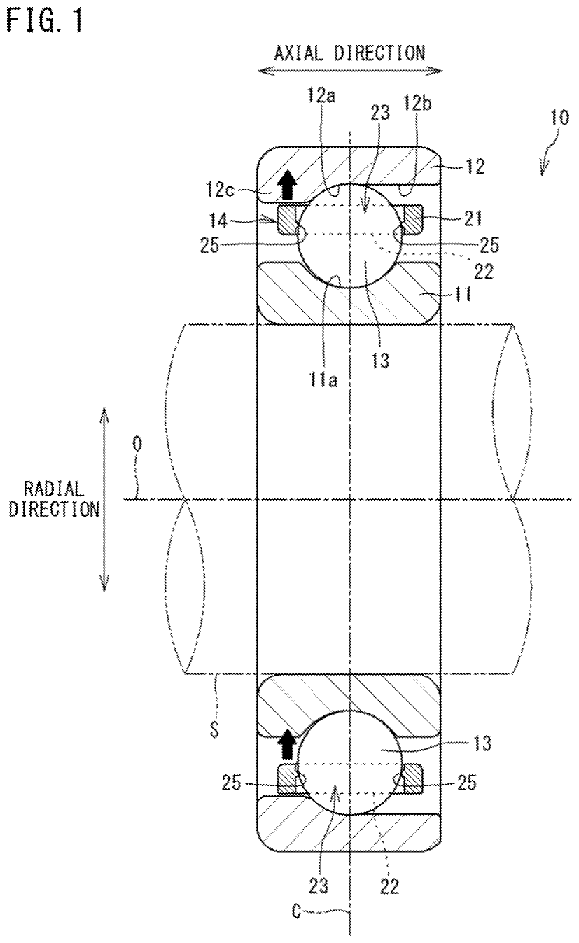

FIG. 1 is a cross-sectional view of a ball bearing according to a first embodiment of the present invention.

The ball bearing 10 of this embodiment is an angular contact ball bearing used for supporting a main shaft of a machine tool, such as, e.g., a machining center and an NC lathe. The angular contact ball bearing 10 is provided with an inner ring 11, an outer ring 12, a plurality of balls 13, and a cage 14.

Note that in this specification, when simply referring to an “axial direction”, a “radial direction”, or a “circumferential direction”, they mean the axial direction, the radial direction, or the circumferential direction of the angular contact ball bearing 10 (the inner ring 11, the outer ring 12, or the cage 14), respectively.

The inner ring 11 is a ring-shaped member outwardly fixedly fitted to a shaft S, such as, e.g., a main shaft of a machine tool. An arc-shaped raceway (raceway groove) 11a is formed on the outer circumference of the inner ring 11.

The outer ring 12 is a member which is to be inwardly fixedly fitted to a housing H. An raceway 12a is formed on the inner circumference of the outer ring 12. A counterbore 12b is formed adjacently on one axial direction side of the raceway 12a. A shoulder 12c is formed adjacently on the other axial side of the raceway 12a. The counterbore 12b is larger in inner diameter than the shoulder 12c.

A plurality of balls 13 is arranged at intervals in the circumferential direction between the raceway 11a of the inner ring 11 and the raceway 12a of the outer ring 12. The plurality of balls 13 rolls on both the raceways 11a and 12a. The ball 13 contacts the raceways 11a and 12a at a contact angle. The ball 13 is capable of receiving both the axial load and the radial load.

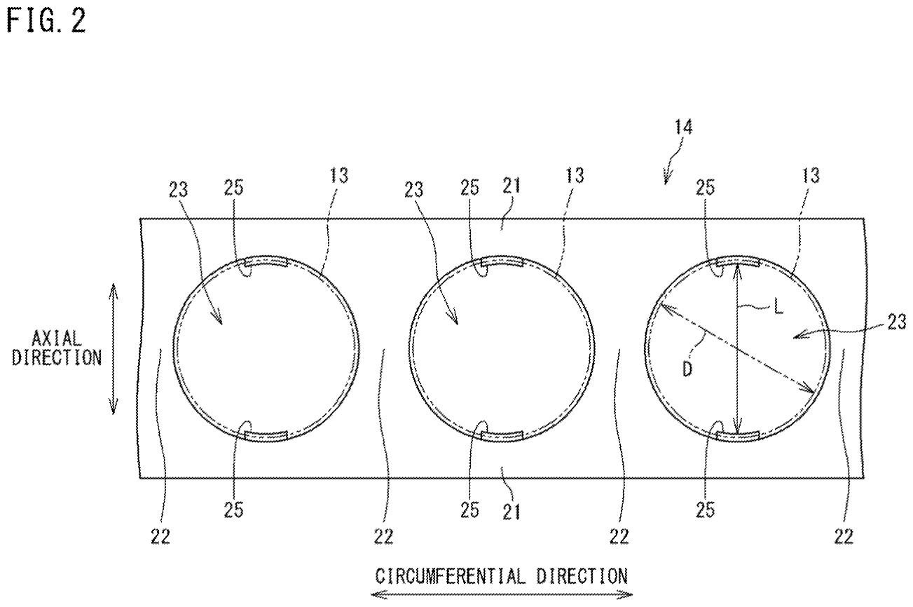

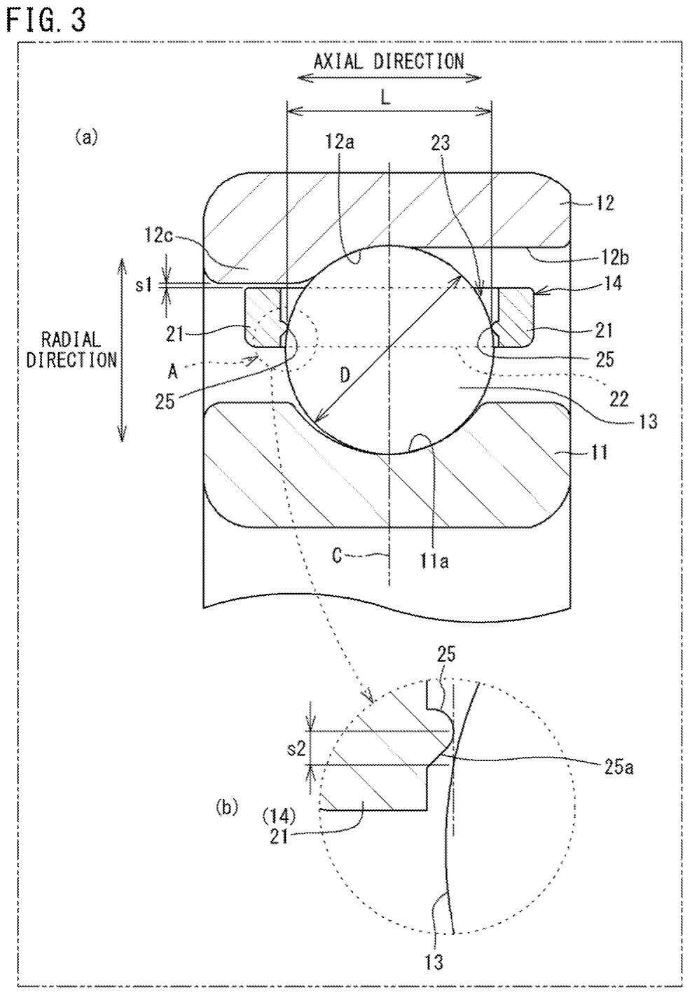

FIG. 2 is a schematic view of a part of the cage as seen from a radially outward side.

As shown in FIG. 1 and FIG. 2, the cage 14 is formed in a circular ring shape and maintains the circumferential intervals of the plurality of balls 13. The cage 14 is made of a synthetic resin material, such as, e.g., a polyamide resin and polyetheretherketone (PEEK). The cage 14 is composed of annular bodies 21 and cage bars 22. The cage 14 is manufactured, for example, by injection molding.

The annular bodies 21 are each formed in an annular shape, and a pair of annular bodies 21 is arranged at an interval in the axial direction.

The cage bars 22 extend between the pair of annular bodies 21. A plurality of cage bars 22 is provided at intervals in the circumferential direction.

Pockets 23 each for accommodating a ball 13 are formed between the pair of annular bodies 21 and the plurality of cage bars 22. As shown in FIG. 2, a plurality of pockets 23 is formed at intervals in the circumferential direction. When the cage 14 is viewed from the radially outward side, the pocket 23 is formed in a circular shape.

As shown in FIG. 1, the cage 14 is configured such that the outer circumference surface of one of the annular bodies 21 can come into slide contact with the inner circumference surface of the shoulder 12c of the outer ring 12. With this configuration, the cage 14 is positioned in the radial direction by the outer ring 12, so that the vibrations in the radial direction are suppressed. That is, the angular contact ball bearing 10 of this embodiment is a bearing of a type (outer ring (raceway ring) guide type) in which the rotation of the cage 14 is guided by the outer ring 12. In this case, the outer ring 12 serves as a guide ring, and the inner circumference surface of the shoulder 12c serves as a guide surface.

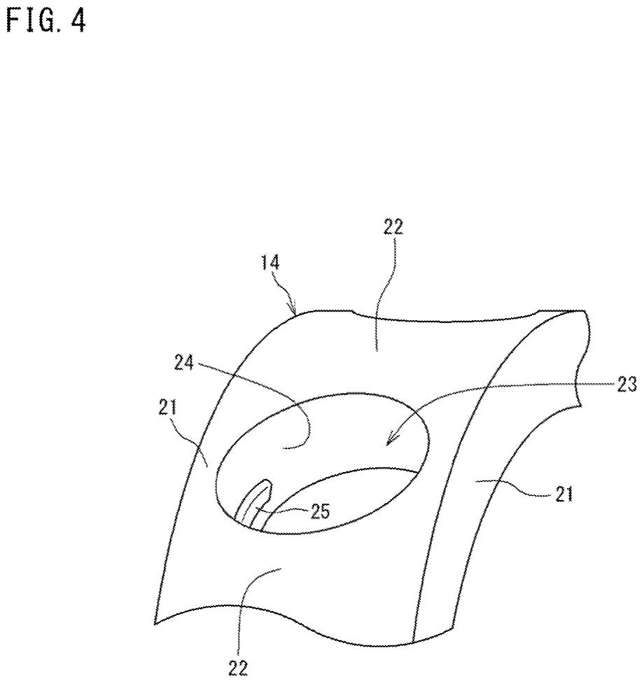

(a) of FIG. 3 is an enlarged cross-sectional view of a part of the ball bearing, and (b) of FIG. 3 is an enlarged cross-sectional view of the portion A indicated in (a) of FIG. 3. FIG. 4 is an enlarged perspective view of a part of the cage.

Inside the pocket 23, engaging portions 25 which project into the pocket 23 are provided. More specifically, a pair of engaging portions 25 is provided so as to face each other at both ends of the pocket 23 in the axial direction of the cage 14. The cross-sectional shape of the tip of the engaging portion 25 is formed in an arc shape. The radially inner part 25a of the engaging portion 25 positioned inner than the tip of the engaging portion 25 is inclined so that the protrusion amount from the inner surface of the pocket 23 gradually decreases as it proceeds radially inward.

As shown in FIG. 2, the distance L between the engaging portions 25 on both axial sides is smaller than the outer diameter D of the ball 13. For this reason, when the cage 14 is moved radially inward, the pair of engaging portions 25 engages with the ball 13 accommodated in the pocket 23.

The position of the engaging portion 25 in the pocket 23 is set as follows.

As the inner ring 11 rotates, the cage 14 also rotates. When radial vibrations occur in the cage 14, a part of the outer circumference surface of the cage 14 comes into contact with the inner circumference surface of the shoulder 12c of the outer ring 12, so the cage 14 is positioned in the radial direction. As described above, the position of the engaging portion 25 is set such that the engaging portion of the pocket 23 positioned on the radially opposite side of the part of the outer circumference surface of the cage 14 engages with the ball in the pocket 23 prior to the contact of the part of the outer circumference surface of the cage 14 to the shoulder 12c of the outer ring 12. Therefore, the impact due to the contact of the cage 14 to the shoulder 12c of the outer ring 12 is reduced, so that the contact sound and the collision sound between the cage 14 and the outer ring 12 are suppressed. This makes it possible to reduce the noise due to the rotation of the shaft S.

In particular, in the case of an angular contact ball bearing 10 which supports a shaft S rotating at a high speed as in the case of a main shaft of a machine tool, the problems of the contact sound and the collision sound between the cage 14 and the outer ring 12 become more noticeable. Therefore, by providing the engaging portions 25 in the pocket 23, the problems can be suitably suppressed.

Further, when small vibrations occur in the cage 14 during the rotation of the cage 14, the vibrations are suppressed by the engagement of the engaging portion 25 with the ball 13, and the rotation of the cage 14 can be stabilized. When the cage 14 experiences greater vibrations, the outer circumference surface of the cage 14 comes into contact with the inner circumference surface of the shoulder 12c of the outer ring 12, which in turn can stabilize the rotation. Thus, it can be said that the cage 14 of this embodiment is guided in two manners, i.e., a ball guide manner in which the rotation is guided by the ball 13 and an outer ring guide manner in which the rotation is guided by the outer ring 12, and the ball guide functions prior to the outer ring guide.

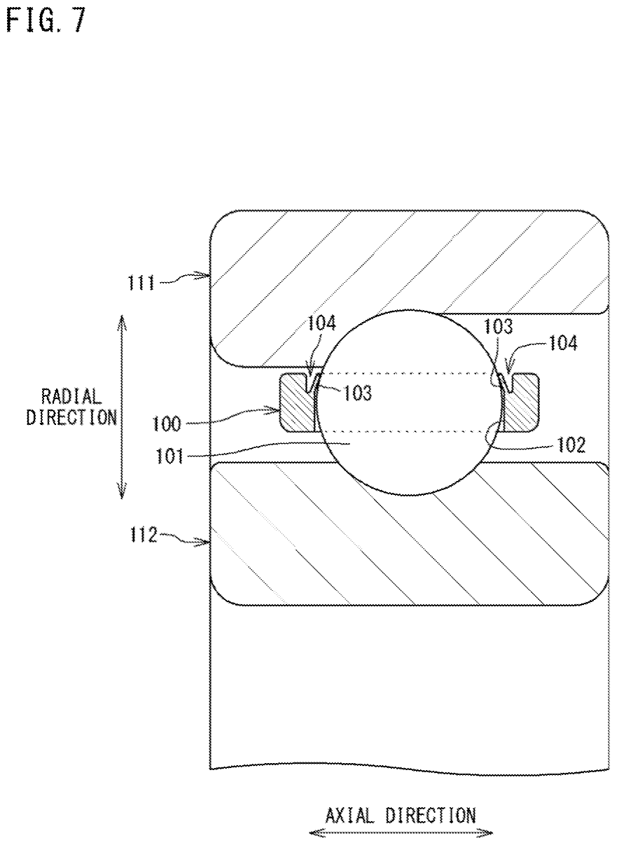

Note that the present applicant has proposed an angular contact ball bearing provided with a cage made of synthetic resin as shown in FIG. 7 (see Japanese Patent Application No. 2019-011559). In the cage 100, a pair of plate-like retaining portions 103 is provided at radially outer ends of a pocket 102 for accommodating a ball 101 rotatably disposed between an outer ring 111 and an inner ring 112. The pair of retaining portions 103 protrudes toward the inside of the pocket 102 to be engaged with the ball 101, thereby retaining the ball 101 from the pocket 102. It is considered that each retaining portion 103 can also suppress radial vibrations of the cage 100 by contacting the ball 101 when the cage 100 vibrates in the radial direction.

However, in the vicinity of the retaining portion 103 of the cage 100, a groove 104 required for taking out the retaining portion 103 from a molding die after molding the retaining portion 13 by the molding die is formed. More specifically, the groove 104 serves as a space for deforming (curving) the retaining portion 103 so as to enable forced removal when the molding die is retracted after molding. By forming such a groove 104, the retaining portion 103 can be formed without applying a complicated mold structure. However, since the retaining portion 103 is deformed for each shot and discharged from the molding die, it is inevitable that some variation occurs in the dimension of the retaining portion 103. Therefore, as compared with the engaging portion of this embodiment, the retaining portion 103 is slightly inferior in terms of dimensional accuracy with respect to the ball 101 and in terms of vibration-reducing effects.

In this embodiment, there is no such problem that the engagement with the ball 101 varies due to the dimensional variation as in the retaining portion 103 shown in FIG. 7, and the vibrations of the cage can be suitably suppressed.

Hereinafter, an example of the dimensional relationship between the engaging portion 25 and the ball 13 in the pocket 23 will be described.

As shown in FIG. 1, in a state in which the axial centers O of the outer ring 12, the inner ring 11, and the cage 14 coincide with each other and the centers C in the axial direction of the outer ring 12, the inner ring 11, and the cage 14 coincide with each other, as shown in (a) of FIG. 3, a gap s1 is formed between the outer circumference surface of the cage 14 and the inner circumference surface of the shoulder 12c of the outer ring 12.

In contrast, there is a slight gap in the radial direction between the surface of the ball 13 and the engaging portion 25, as shown in (b) of FIG. 3. The minimum value s2 of the gap is smaller than the gap s1 between the inner circumference surface of the shoulder 12c of the outer ring 12 and the outer circumference surface of the cage 14. The gap s2 may be 0 (s2=0).

When vibration occurs in the cage 14 in the radial direction (e.g., upward vibration) as indicted by the arrow in FIG. 1 due to the rotation of the shaft S, the upper portion of the cage 14, which is a part of the outer circumference surface of the cage 14, comes into contact with the inner circumference surface of the shoulder 12c of the outer ring 12, so that the cage 14 is positioned. Specifically, the cage 14 is positioned in the following process. Since the gaps s1 and s2 between the cage 14 and the outer ring 12 and between the cage 14 and the ball 13 are set to s1>s2 (where s2>0), the engaging portion 25 first engages with the ball 13 in the pocket 23 in the vicinity of the lower portion side of the cage 14. Thereafter, when the cage 14 attempts to move further in the radial direction (upward direction), the upward movement of the cage 14 is permitted by the bending of the cage 14, the elastic deformation of the engaging portion 25, and the like. With this, the outer circumference surface of the cage 14 comes into contact with the inner circumference surface of the shoulder 12c of the outer ring 12 at the upper portion of the cage 14.

### Second Embodiment

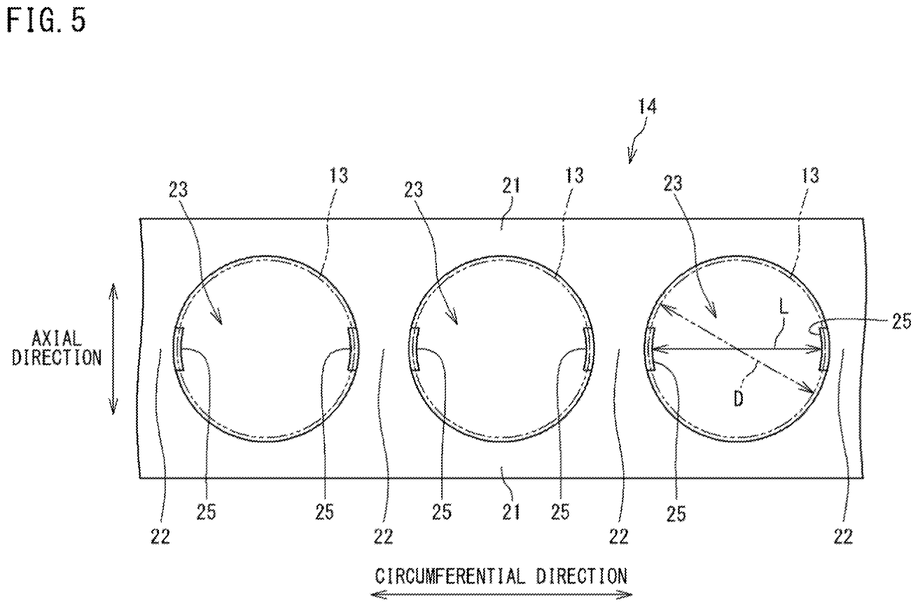

FIG. 5 is a schematic view of a part of a cage of a ball bearing according to a second embodiment as seen from a radially outward side.

In the above-described embodiment, the pair of engaging portions 25 in the pocket 23 is provided at axially opposite positions. On the other hand, in this embodiment, a pair of engaging portions 25 is provided at positions facing in the circumferential direction. Such a configuration also has the same operation and effect as those of the above-described embodiment.

### Third Embodiment

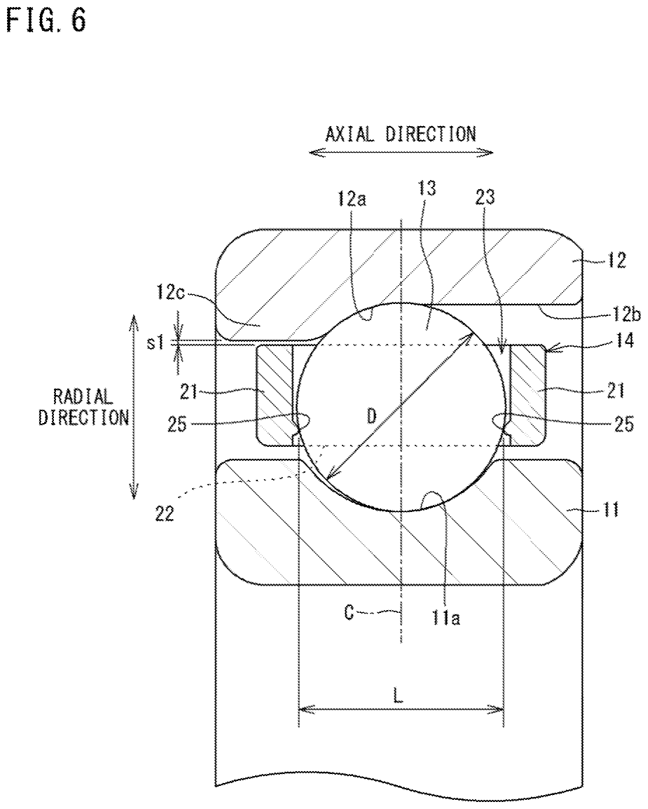

FIG. 6 is an enlarged cross-sectional view of a part of a ball bearing according to a third embodiment.

In this embodiment, a pair of engaging portions 25 provided in the pocket 23 of the cage 14 is arranged so as to engage with the ball 13 from the radially inward side. When radial vibration occurs in the cage 14, the engaging portions 25 of the pocket 23 positioned in the vicinity of a part of the outer circumference surface of the cage 14 engages with the ball 13 prior to the contact of the part of the outer circumference surface of the cage 14 to the inner circumference surface of the shoulder 12c of the outer ring 12. Therefore, the impact due to the contact of the cage 14 to the shoulder 12c of the outer ring 12 is reduced, so that the contact sound and the collision sound between the cage 14 and the outer ring 12 are suppressed. This makes it possible to reduce the noise due to the rotation of the shaft S.

The present invention is not limited to the above-described embodiments and can be appropriately modified within the scope of the present invention.

For example, the cage 14 may be provided with a pair of engaging portions 25 (see FIG. 2) according to the first embodiment and a pair of engaging portions 25 (see FIG. 5) according to the second embodiment in a combined manner. In other words, the cage 14 may be provided with two pairs of engaging portions 25. Note that the pair of engaging portions 25 may be provided so as to face each other in a direction inclined to the axial direction and the circumferential direction. From the viewpoint of mold forming, it is extremely difficult to provide the engaging portion 25 on the entire circumference of the inner surface of the pocket 23, and therefore, it is more preferable to provide one pair or a plurality of pairs of the engaging portions 25.

In the above embodiment, the raceway 11a of the inner ring 11 is formed in an arc shape, and the shoulder is formed on both axial sides of the raceway 11a, but a counterbore may be formed in one axial direction of the raceway 11a.

In the above-described embodiment, the engaging portion 25 is inclined such that the protrusion amount from the inner surface of the pocket 23 gradually decreases as it proceeds radially inward from the tip, but may be formed in a semi-circular arc shape in the same manner as in the case of the upper part than the tip.

The angular contact ball bearing according to the present invention is not limited to be used for supporting a main shaft of a machine tool, but can be used for all applications.

Further note that the present invention can also be applied to a ball bearing other than an angular contact ball bearing.

The cage 14 may be of an inner ring guide type.

### DESCRIPTION OF SYMBOLS

10: ball bearing
11: inner ring
11a: raceway
12: outer ring
12a: raceway
12b: counterbore
12c: shoulder
13: ball
14: cage
23: pocket
25: engaging portion

1. A ball bearing comprising:
an outer ring provided with a raceway on an inner circumference;
an inner ring arranged radially inward of the outer ring and provided with a raceway on an outer circumference;
a plurality of balls arranged between the raceway of the outer ring and the raceway of the inner ring; and
a cage configured to maintain circumferential intervals of the plurality of balls,
wherein the cage is provided with a plurality of pockets each for accommodating the ball at circumferential intervals and is configured to be rotationally guided by the outer ring or the inner ring, which serves as a guide ring,
wherein the pocket is provided at an inner surface thereof with an engaging portion which projects into the pocket, and
wherein the engaging portion engages with the ball in the pocket prior to contact of the cage to the guide ring when the cage is moved in a radial direction.

2. The ball bearing as recited in claim 1,
wherein the guide ring is provided with a guide surface to which the cage comes into contact, and
wherein a radial gap between the engaging portion and the ball is smaller than a radial gap between the guide surface and the cage.

3. The ball bearing as recited in claim 1,
wherein the outer ring is provided with a counterbore arranged on one axial side of the raceway and a shoulder arranged on the other axial side of the raceway, and an inner circumference surface of the shoulder serves as a guide surface for guiding rotation of the cage.

4. The ball bearing as recited in claim 1,
wherein the engaging portion engages with the ball in the pocket from a radially outward side.

5. The ball bearing as recited in claim 1,
wherein the engaging portion is composed of a pair of engaging portions provided to face each other.

6. A cage for maintaining circumferential intervals of a plurality of balls in a ball bearing,
wherein the cage is provided with a plurality of pockets for accommodating the balls and rotation of the cage is guided by an outer ring or an inner ring of the ball bearing, which serves as a guide ring,
wherein the pocket is provided at an inner surface thereof with an engaging portion which projects into the pocket, and
wherein the engaging portion engages with the ball in the pocket when the cage is moved in a radial direction prior to contact of the cage to the guide ring.
